(19) United States
(12) Patent Application Publication
(10) Pub. No.: US 2015/0211667 A1
(43) Pub. Date: Jul. 30, 2015

(54) Method For Conveying Fluids Under High Pressure

(71) Applicant: Seann Pavlik, Fort Lauderdale, FL (US)

(72) Inventor: Seann Pavlik, Fort Lauderdale, FL (US)

(21) Appl. No.: 14/581,740

(22) Filed: Dec. 23, 2014

Related U.S. Application Data
(63) Continuation-in-part of application No. 13/489,225, filed on Jun. 5, 2012, now abandoned.
(60) Provisional application No. 61/520,100, filed on Jun. 6, 2011.

(51) Int. Cl. F16L 33/18; F16L 33/24

(52) U.S. Cl. CPC F16L 33/18; F16L 33/24

(57) ABSTRACT

A method for conveying a fluid under high pressure includes a first conduit including an outer diameter provided with a surface of a selectable property of flatness, roughness, irregularity or threaded, a second conduit having an inside diameter complemental to the outer diameter to the first conduit. The fitting method further includes a circumferential sealing element for coupling the second conduit to the first conduit after the first conduit is inserted past a smooth circular interior entrance of the second conduit. The first conduit is advanced within the second conduit to the internal threads which engage the selectable properties of the input of the surface of the first conduit. The diameter of the sealing element typically exceeds the outside diameter of the first conduit by a range of 5% to 50%.

### CROSS REFERENCE TO RELATED APPLICATIONS

This application claims the benefit under 35 USC 119 (e) of the provisional patent application Ser. No. 61/520,100, filed Jun. 6, 2011, and is a continuation-in-part of application Ser. No. 13/489,225, filed Jun. 5, 2012, both of which are hereby incorporated by reference in their entirety.

### FIELD OF THE INVENTION

Embodiments of the present invention generally relate to a method for conveying fluids under high pressure.

### BACKGROUND OF THE INVENTION

Numerous systems are used to transport fluid in household and industrial applications. Generally, these systems employ pipes and tubes and typically suffer from the problem of fluid leakage occurring within the junction between the pipe to be fitted and the piping already in place. Moreover, frequent fluid leakage is also seen at the distal end of piping.

Currently, the outer threads of a pipefitting are wound with several rounds of seal tape so as to eliminate the gaps between the assembled pipefitting and corresponding assembling structure, to prevent the occurrence of leakage. However, this technique has little effect on leakage prevention where high pressures are involved, e.g., over 150 p.s.i. Moreover, the overall technique of using seal tape is laborious and requires much more time. Furthermore, the seal tape cannot be used, and then re-used so there is wastage of seal tape.

Hydraulic couplings have also been employed to prevent the occurrence of leakage. In operation, hydraulic couplings provide a sealing means for a coupling element when it is in an uncoupled configuration and an O-ring is housed at the interface between the pusher conduit and the valve. While one conduit is coupled with an opposing conduit, a sliding valve relative to the pusher positions may contact the sealing O-ring at a fluid flow section in the coupling. However, with high fluid pressures and flow rates, there remains a possibility that the sealing O-ring may be expelled from its circumferential housing when the coupling is engaged, consequently causing a sealing problem or decoupling of the conduits.

In the prior art, methods are known for creating a fitting between a threaded and unthreaded conduit, this as is reflected in U.S. Pat. No. 4,054,305 (1977) to Gajajiva et al, entitled Thread Making Fitting for Unthreaded Conduit. While art such as Gajajiva makes use of a resilient gasket or sealing element, the length of one end of a joined conduit to another does not extend beyond the sealing element.

Other art is concerned primarily with the exclusion of fluid from the interior of a conduit (as opposed to conveying the fluid under pressure), as in electrical, communications and fiber optic applications. Such art employs complex tapered surfaces as is reflected in U.S. Pat. No. 6,059,321 (2000) to Lyall, entitled Grip Coupling for Joining Conduit. Such art, in addition, makes use only of metallic elements and recites the lack of suitability of non-metallic materials in such applications, i.e., the exclusion of fluids from sensitive electronic, optical and communications equipment. Of necessity, this art is more complex and tolerances more sensitive than is the novel method set forth herein. As such, the art represented by Lyall is not concerned with the conveyance of fluids under high pressure but, rather, simply that of protecting of wiring, optics and other equipment from external pressure, impact and the like.

Accordingly, there remains a need for an improved fitting method for conveying fluids under high pressure and preventive of fluid leakage therefrom. The present invention addresses this long felt need in the art.

### SUMMARY OF THE INVENTION

The within invention relates to a method for confining and conveying fluid at a pressure of about 150 to about 2500 psi within a fluid pathway. The method comprises the steps of: (a) providing a high pressure input to a polymeric first conduit, said conduit having a distal end including an outer diameter having a defined portion proximally to an output of said first conduit; (b) providing a second conduit having a proximal end, said end having an internal diameter press-fittably complemental to said defined portion of said outer diameter of said first conduit; (c) circumferentially housing within a recess within a surface of said proximal end of said internal diameter of said second conduit, a sealing element having axial and radial resilience thereof; (d) providing within a surface of said interior diameter of said second conduit, downstream of said sealing element, a threaded region thereof; (e) rotatably inserting said distal end of said first conduit within said proximal end of said second conduit; (f) rotatably advancing said distal end of said first conduit into said internal diameter of said second conduit past said sealing element; and (g) further rotatably advancing said distal end of said first conduit into said threaded region of said interior diameter of said second conduit, in which said sealing element defines a fluid lock between the exterior of said first conduit and the interior diameter of said second conduit, and said distal end of said first conduit is mechanically engaged by said threaded region of said second conduit, thereby effecting a fluid seal or lock therebetween. The diameter of said sealing element typically exceeds the outside diameter of the first conduit by a range of about 5% to about 50%.

In accordance with an embodiment of the present invention, the sealing means may include at least one axially and radially resilient gasket or O-ring. The at least one gasket is mounted circumferentially within the inner diameter of the smooth circular end before a beginning of a region of multiple threads. Particularly, the at least one gasket in combination with said threaded region define a fluid-tight press-fit to the first conduit sufficiently inserted into the second conduit, enabling conveyance of the fluid under high pressure without loss of integrity of pressure or fluid flow.

### BRIEF DESCRIPTION OF THE DRAWINGS

FIG. 1 illustrates a perspective view of a first conduit and a second conduit of a fitting method for conveying fluids under high pressure in an unassembled position, according to an embodiment of the invention.

FIG. 2 and FIG. 3 are perspective views of the first conduit inserted inside the second conduit to form the fitting method for conveying fluids under high pressure, according to an embodiment of the invention.

FIG. 4 illustrates a cross-sectional view of the first conduit and the second conduit of the fitting method along the axis of rotation of the fitting assembly of FIG. 3, according to an embodiment of the invention.

FIG. 5 illustrates a cross-sectional view of the first conduit inserted inside the second conduit to form the fitting method for conveying fluids under high pressure, taken along Line 5-5 of FIG. 3.

### DETAILED DESCRIPTION OF THE INVENTION

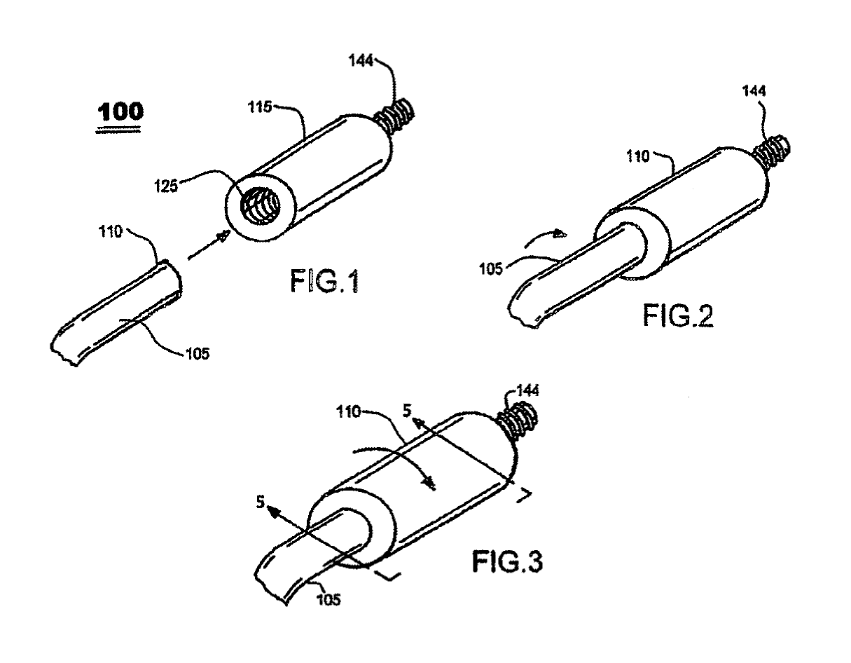

With reference to FIGS. 1-5, a fitting method for conveying a fluid under high pressures includes a first preferably flexible conduit 105 including an end 110 on an outer diameter of the conduit 105. The fitting assembly 100 further includes a second conduit 115 of circular cross-section defining an inner diameter 125 to receive the first conduit 105. Particularly, the second conduit 115 includes a smooth circular input 123 which enables said inner diameter 125 to position the first conduit 105 in place inside the second conduit 115 having, downstream, a threaded end with multiple threads 130 upon the inner diameter 125 beyond the smooth circular proximal and or end 125. Threads 130 engage the first conduit 105 inside the second conduit 115 as illustrated in cross-sectional view of FIG. 5. The conduits 105 and 115 possess a common axis of rotation of the coupled assembly.

The present method further employs a circumferential sealing element, gasket or O-ring 135, coupling the second conduit 115 to the first conduit 105 after end 110 of the first conduit is inserted into the smooth input 123 of the second conduit 115. Generally, the sealing element 135 is located within a circumferential groove of the second conduit 115 and must be positioned before the threads 130. Therein as illustrated in FIG. 5 the first conduit 105 is preferably rotatably inserted inside the second conduit 115 to form a fitting assembly 100 for conveying fluids under high pressure, according to an embodiment of the invention.

In use, the first conduit 105, whether threaded or not, is rotatably inserted within the multiple threads 130 of the second conduit 115 and the outer diameter of the first conduit 105 is in rotational communication with the inner diameter 125 of the second conduit 115 to form the fitting assembly 100 as illustrated in FIGS. 2, 3 and 5 of the invention.

In another embodiment in which the first conduit is less flexible, insertion of the first conduit into the second may be more linear or step-like in character.

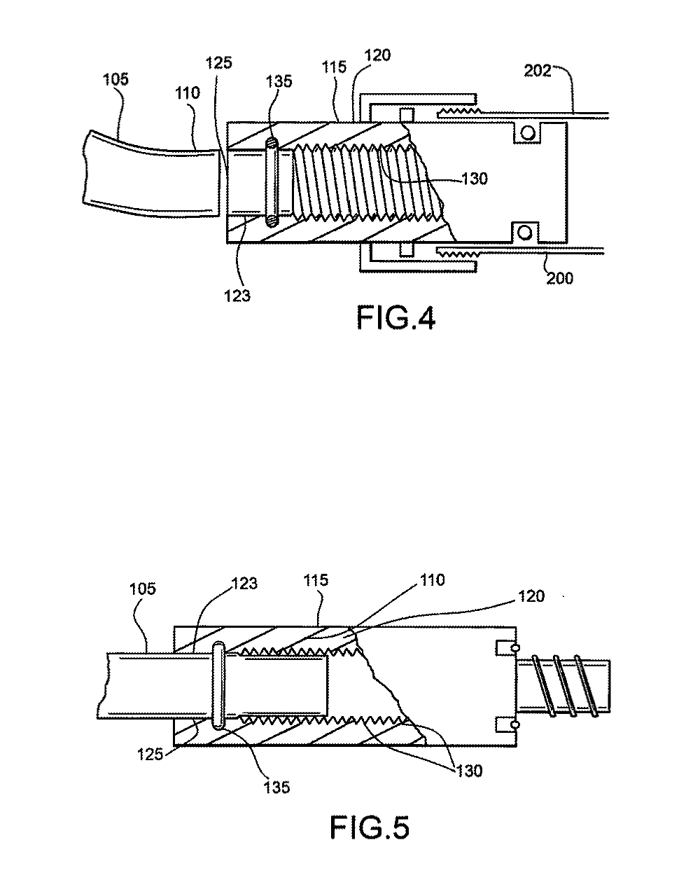

In accordance with all embodiments of the invention, the sealing element 135 includes at least one resilient gasket which is circumferentially mounted within the inner diameter 125 after the mouth or proximal end 123 of conduit 115 before a beginning of the multiple threads 130 as illustrated in FIGS. 4-5. Said inner diameter may be in a range of 4.0 to 20 mm or more but preferably is about 8.0 mm. Particularly, the at least one sealing element 135 (preferably located about 3 mm beyond the mouth 123 of conduit 115, defines a fluid-tight press-fit to the first conduit 105 when the conduits are joined, enabling conveyance of the fluid under high pressure without loss of integrity of pressure or rate of fluid flow. An optional assembly securing collar 200 with its female portion 202 is also shown in FIG. 4 which also illustrates that end 110 of the finest conduit may be either roughened, irregular, threaded or smooth, without regard to the material or flexibility of the first conduit.

In use, the gasket 135 is mounted in a circumferential recessed groove formed within the inner diameter (ID) at or beyond 3 mm beyond proximal end 123 of conduit 115. That is, the circular proximal end 110 of the first conduit 105 is inserted into mouth 123 of conduit 115 and passes beyond the gasket to threads 130. In operation, the fluid flow deforms at least a portion of the resilient element or gasket 135 in both radial and axial directions. The at least one gasket 135 of the invention is preferably an O-ring, producing a fluid-tight seal between the first conduit 105 and the second conduit 115, downstream of mouth or proximal end 123. The diameter of O-ring 135 will typically fall within a range of 5% to 50% greater than the outside diameter of inserted conduit 105. Moreover, O-ring 135 in combination with threads 130, perform a locking and sealing function in the present method.

A preferred ratio of the ID of the second conduit to the placement of the 0-ring from the mouth 123 of the conduit 115 is in a range of 2:1.5 to 5/5:1.

It is noted multiple threads may be applied to distal end 110 of the first conduit 105 which then is rotably or linearly inserted into the inner diameter 123 of the smooth circular end of the second conduit 115 while the O-ring 135 is press-fit against the outer diameter of the first conduit 105 before and during contact with the multiple threads 130. An interlock is caused by the effect of such portions against each other. Such is also the case where distal end of conduit 105 is simply roughened or provided with an irregular surface. See FIG. 4.

In accordance with an embodiment of the invention, the first conduit 105 may be formed of a flexible polymeric material. Particularly, the flexible polymeric material is selected from at least one of a lower density polymeric material, other plastic material or the like. Furthermore, the lower density polymeric material is preferably polystyrene. However, the present invention is not limited to low density polymeric materials and any other suitable material or plastic or composite material, whether flexible or not, strong enough for the intended use may be employed. Therefore, in an alternate embodiment, the first conduit 105 may be formed of a rigid material including a rigid plastic such as a polycarbonate or a metal.

In accordance with a further embodiment, the second conduit 115 is formed of a rigid material. Particularly, the rigid material may be a type of metal selected from aluminum, copper, copper alloys such as brass, tin and the like.

Therefore, as may be seen, the invention provides a method for conveying fluids under high pressures which serves to prevent leakage of a fluid flowing under high pressure through the conduit. The combination of the O-ring 135 near the entrance 123 to the second conduit, its pressure against first conduit 105, and the interlock of the threaded region 130 to the exterior of the first conduit results in high pressure locking of the first and second conduits through which high pressure fluids may then safely pass.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith. Therefore, the appended claims are to be construed to encompass all equivalents falling within the scope and spirit of this invention.

1. A method for confining and conveying fluid at a high pressure in a range of about 150 to about 2500 psi within a fluid pathway, the method comprising the steps of:
(a) providing a high pressure fluid input to a flexible first conduit, said conduit having a distal end including an outer diameter having a defined portion proximally to an output of said first conduit;
(b) providing a second conduit having a proximal end, said end having a smooth internal diameter press-fittably complemental to said defined portion of said outer diameter of said first conduit;
(c) circumferentially housing within a recess within a surface of said proximal end of said internal diameter of said second conduit, a sealing element having axial and radial resilience thereof;
(d) providing within a surface of said interior diameter of said second conduit, downstream of said sealing element, a threaded region thereof;
(e) rotatably inserting said distal end of said first conduit within said proximal end of said second conduit;
(f) rotatably advancing said distal end of said first conduit into said internal diameter of said second conduit past said sealing element; and
(g) further rotatably advancing said distal end of said first conduit into said threaded region of said interior diameter of said second conduit, in which said sealing element defines a fluid lock between the exterior of said first conduit and the interior diameter of said second conduit, and said distal end of said first conduit is mechanically engaged by said threaded region of said second conduit, effecting a fluid seal therebetween.

2. The method as recited in claim 1, further comprising the step of:
providing a roughened surface to said defined distal portion of said first conduit.

3. The method as recited in claim 1, further comprising the step of:
providing an irregular surface to said defined portion of said distal end of said first conduit.

4. The method as recited in claim 1, further comprising the step of:
providing a threaded surface to said defined portion of said distal end of said first conduit.

5. The method as recited in claim 1, further comprising the step of:
providing a smooth surface to said defined portion of said distal end of said first conduit.

6. The method as recited in claim 1, in which said flexible first conduit comprises a polymeric tube.

7. The method as recited in claim 1, in which said method further comprises the step of:
providing said sealing element in the form of an O-ring.

8. The method as recited in claim 6, further comprising the step of:
forming said polymeric tube of a polystyrene material.

9. The method as recited in claim 1, further comprising the step of:
forming said second conduit of a material having a greater density than that of a material of said first conduit.

10. The method as recited in claim 9, further comprising the step of:
providing a metal as the material of said second conduit.

11. The method as recited in claim 1, in which the ratio of the dimension of the internal diameter of the second conduit to the location of said sealing element from the second conduit input defines a range of 2.0:1.5 to 5.0:1.0.

12. A method for confining and conveying fluid of a high pressure of about 150 to about 2500 psi within a fluid pathway, the method comprising the steps of:
(a) providing said high pressure fluid input to a flexible first conduit, said conduit having a distal end including an outer diameter having a defined portion proximally to an output of said first conduit;
(b) providing a second conduit having a proximal end, said end having an internal diameter press-fittably complemental to said outer diameter of said end of said first conduit, in which a material of said conduit comprises a metal having a greater density than that of said first conduit.
(c) circumferentially housing within a recess within a surface of said proximal end of said internal diameter of said second conduit, a sealing element having axial and radial resilience thereof;
(d) providing within a surface of said interior diameter of said second conduit, downstream of said sealing element, a threaded region thereof;
(e) advancing said distal end of said first conduit into said proximal end of said second conduit;
(f) further advancing said distal end of said first conduit into said internal diameter of said second conduit and past said sealing elements; and
(g) yet further advancing said distal end of said first conduit into said threaded region of said interior diameter of said second conduit, in which said sealing element defines a fluid lock between an exterior of said first conduit and an interior diameter of said second conduit, and said distal end of said first conduit is mechanically engaged by said threaded region of said second conduit to effect a fluid seal therebetween.

13. The method as recited in claim 12, further comprising the step of:
providing a roughened surface to said defined distal portion of said first conduit.

14. The method as recited in claim 12, further comprising the step of:
providing an irregular surface to said defined portion of said distal end of said first conduit.

15. The method as recited in claim 12, The method as recited in claim 1, further comprising the step of:
providing a threaded surface to said defined portion of said distal end of said first conduit.

16. The method as recited in claim 12, further comprising the step of:
providing a smooth surface to said defined portion of said distal end of said first conduit.

17. The method as recited in claim 12, in which said first conduit comprises a polymeric tube.

18. The method as recited in claim, 12, in which the ratio of the dimension of the internal diameter of the second conduit to the location of said sealing element from the second conduit input defines a range of 2.0:1.5 to 5.0:1.0.

19. The method as recited in claim 1, in which the diameter of said sealing element exceeds the outside diameter of the first conduit by a range of 5% to about 50%.

20. The method as recited in claim 12, in which the diameter of said sealing element exceeds the outside diameter of the first conduit by a range of 5% to about 50%.
